(19) United States
(12) Patent Application Publication
(10) Pub. No.: US 2014/0174334 A1
(43) Pub. Date: Jun. 26, 2014

(54) Automobile Flagpole

(71) Applicant: William Christopher Tucker, Mountian Brook, AL (US)

(72) Inventor: William Christopher Tucker, Mountian Brook, AL (US)

(21) Appl. No.: 13/959,837

(22) Filed: Aug. 6, 2013

Related U.S. Application Data
(60) Provisional application No. 61/742,226, filed on Aug. 6, 2012.

(51) Int. Cl. G09F 17/00

(52) U.S. Cl. CPC G09F 17/00
USPC 116/173

(57) ABSTRACT

An automobile flagpole comprising a clip portion, where the clip portion is “U” shaped in order to fit over an automobile window and to be held in place when the window is in the up position; a straight portion that extends upwards from the exterior portion of the clip, with an attached flag; the interior portion of the clip extends downward and one or more suction cups are attached in such a way to limit forces applied upon the flagpole from reaching the suction cup(s); thus allowing the flagpole to be operated on the automobile with the window either up or down.

### CROSS-REFERENCE TO RELATED APPLICATIONS

This application claims the benefit of U.S. Provisional Patent Application 61/742,226, which was filed on Aug. 6, 2012, the entire disclosure of which is hereby incorporated by reference.

### STATEMENT REGARDING FEDERALLY SPONSORED RESEARCH OR DEVELOPMENT

Not Applicable

### REFERENCE TO SEQUENCE LISTINGS, A TABLE, COMPUTER PROGRAM LISTING COMPACT DISC APPENDIX

Not Applicable

### BACKGROUND OF THE INVENTION

1. Field of the Invention

This invention generally relates to automobile flags. Particularly to window mounted automobile flags and more particularly to window mounted automobile flags that comprise a clip that fits over the top of an automobile's side window and is held in place by the window and window frame when the window is rolled up. Specifically, this invention comprises a flag mounting system in which the window can be rolled down or partially rolled down and the flag mounting system will stay in place and will not blow off of the vehicle at normal driving speeds.

2. Description of Related Art

Decorating vehicles with flags is common, particularly American flags and sports teams' flags. One very common method of attaching a flag to a vehicle is to use a window mounted flagpole. Such flagpoles comprise a “U” shaped clip that fits over the top of the window. The flagpole is secured when the user places the clip over the top of the lowered window then rolls the window up, thus pinning the clip between the window and the window frame. However, such flag poles are intended to operate only when the window is rolled up. Upon lowering the window while the vehicle is moving, the flagpole will blow off of the window. Thus, while the vehicle is moving, the user can not roll down the window or the flag will be lost. More often than not, the user, other passenger or child simply forgets that a flag is on the window and the flag is lost on the highway after the window is mistakenly rolled down.

Another variation of the window mounted flagpole includes a suction cup. The suction cup is either on the base or the side of the flagpole, are attached to the exterior of the window and are exposed to the elements of heat, cold, wind and moisture which cause the suction cup to unseat itself and come loose from the window. Additionally, window mounted flagpoles by nature thrash and blow in the wind at normal driving speeds, thus the flagpole and base move forward and backwards and to and from the car and put a tremendous amount of stress on the suction cup, allowing the suction cup to be pulled loose. Not only do these types of flag poles tend to come loose from the window because of the heat, cold and moisture, but also because the suction cups are attached to the flagpole near the base of the flagpole, which is always in motion while the vehicle is moving. Furthermore, the suction cup is attached rigidly to the pole and there is no give between the two parts. Because the suction cup is on the side or on the base the flagpole, the flagpole not only exerts a vertical pull but also a horizontal pull on the suction cup, which will unseat the suction cup at normal highway speeds. This window mounted suction cup variation is not conducive to normal highway speeds and the flag will more than likely be lost.

Accordingly, it would be desirable to have a window mounted flagpole system that would not come loose from the window should the user or other passenger accidentally roll down the window while traveling. Further, it would be desirable if the user could use the window mounted flagpole for long periods of time at highway speeds with the window up or down.

### SUMMARY OF THE INVENTION

In general, the present invention relates to an automobile flagpole comprising a clip portion in which the clip portion is “U” shaped and fits over the top of an automobile side window in which the flagpole is held in place when the clip is placed over the top of a lowered automobile window and either the window is rolled up, resulting in the clip being pinned in between the window and the associated window frame or when the suction cup(s) on the interior portion of the clip is pressed into place against the window, allowing the flagpole to operate on the moving vehicle with the window ajar. The flagpole comprises a straight portion extending upwards from the exterior portion of the clip with an attached flag.

The portion of the clip on the exterior of the window provides the attachment point for the straight portion of the flagpole at the base and the interior portion of the clip extends downward far enough for the attached suction cups to clear the window frame when the window is completely rolled up, thus allowing the suction cup to stay seated. The clip portion is generally rectangular in order to provide the suction cup(s) adequate leverage to hold the flagpole in place while the vehicle is moving with the window ajar; has a profile shaped like a “U” in order to fit over the top of the window; is thin enough at the bend of the “U” to allow the window to be rolled up or almost rolled up; the interior portion of the clip follows the window down just far enough to clear the window frame then proceeds out and down from the window, then proceeds to follow the plane of the glass, this jutting out allows room for the suction cup(s) between the clip and the glass. The clip has one or more attached suction cup(s) attached to the interior section of the clip, located generally in the corners if more than one suction cup is used. The suction cup(s) are attached on the interior section of the clip because the suction cup(s) are generally protected from the heat, cold, wind and moisture, but primarily because this is the only section of the flag pole that has minimum movement and is not directly in the path of the thrashing pole's path of energy. The suction cup(s) have a narrower portion on the nipple with a slightly smaller diameter than the hole cut in the interior portion of the clip in which the nipple can be inserted through the hole and the larger portion with a larger diameter on the tip of the nipple will hold the suction cup in place, or the suction cups can be attached by adhesive or other means. The above can also be accomplished without the jutting out of the clip, in which the interior of the clip extends straight down to the suction cup(s).

The straight portion of the flagpole may extend up far enough for the flag to clear the top of the roof of the automobile; have a generally round or oval cross-section with a raised edge on either side or other shapes allowing for a more ridged cross-section. The straight portion may have a lip located toward the middle of the pole and a lip at the top of the pole to keep the flag from sliding up or down the pole. The portion of the straight section of the pole that the flag wraps around may be thinner than the section of the lower portion of the pole that attaches to the clip.

In an alternate embodiment, the interior portion of the clip comprises a hinge located just low enough to clear the window frame of the window while in the rolled up position. The portion of the clip above the hinge is the same as the previous embodiment; the lower portion is hinged onto the upper portion allowing flexibility between the upper and lower section and keeping energy transfer between the thrashing flag pole and the suction cup(s) minimal, allowing the suction cup(s) to remain fully seated. Generally the only force exerted on the suction cup(s) is a vertical force allowing the suction cup(s) to maximize its potential and eliminating all horizontal forces that may unseat the cup(s).

In an alternate embodiment to the two listed above, the interior portion of the clip comprises one or more suction cups that are attached to the interior portion of the clip by either a static or dynamic rope(s), spring(s) or other flexible material. The flexible material or rope is connected to the interior portion of the clip just low enough to clear the window frame when the window is in the raised position. The upper portion of the interior portion of the clip is the same as in the two embodiments above except that there are one or more attachment points for the rope or other flexible material to attach to. The suction cups are pulled down from the clip so the rope or other material is taut; additionally, the rope or other material can be pulled down and out to give the suction cup a greater point of leverage. Generally, the only force exerted on the suction cup(s) in this embodiment is a vertical force and all horizontal forces are eliminated allowing the suction cup(s) to stay seated. Additionally, the flexible and dynamic material connecting the suction cup(s) and the interior portion of the clip creates a buffer to limit the forces exerted on the suction cup(s), allowing it to stay seated.

In several alternate embodiments, not preferred to the above, similar technologies to the above may be used on the exterior of the clip to secure the base to the exterior of the window.

### BRIEF DESCRIPTION OF THE DRAWINGS

FIG. 1 is a perspective view of the flagpole mounted on an automobile window with a flag attached.

FIG. 2 is a side view of the flagpole with a cross section of an automobile window and associated window frame (shown in dashed lines to illustrate use of the flagpole).

FIG. 3 is a front view of the flagpole (view from outside the automobile).

FIG. 4 is a rear view of the flagpole.

FIG. 5 is a cross section of the upper portion of the flag pole (the portion that the flag wraps around).

FIG. 6 is a cross section of the lower portion of the flag pole (the portion that connects the upper section of the flagpole to the clip).

FIG. 7 is a side view of another example of the flagpole shown with hinged interior clip, with a cross section of an automobile window and associated window frame (shown in dashed lines to illustrate use of the flagpole).

FIG. 8 is a rear view of another example of the flagpole, shown with a hinged interior clip

FIG. 9 is a side view of another example of the flagpole shown with a flexible material connecting the interior portion of the clip to the suction cup, with a cross section of an automobile window and associated window frame (shown in dashed lines to illustrate use of the flagpole).

FIG. 10 is the rear view of another example of the flagpole, shown with flexible material connecting the interior of the clip to the suction cups.

FIG. 11 is a side view of another example of the flagpole shown with a straight interior clip with no jutted out section and a cross section of an automobile window and associated window frame (shown in dashed lines to illustrate use of the flagpole).

FIG. 12 is a side view of another example of the flagpole shown with flexible material making up the hinge, with a cross section of an automobile window and associated window frame (shown in dashed lines to illustrate use of the flagpole).

FIG. 13 is a side view of another example of the flagpole shown with a weakened area making up the hinge, with a cross section of an automobile window and associated window frame (shown in dashed lines to illustrate use of the flagpole).

FIG. 14 is a side view of another example of the flagpole shown with suction cups on the exterior of the window using a hinged foot, with a cross section of an automobile window and associated window frame (shown in dashed lines to illustrate use of the flagpole).

FIG. 15 is a side view of another example of the flagpole shown with suction cups on the exterior of the window using flexible material as the hinge on the foot, with a cross section of an automobile window and associated window frame (shown in dashed lines to illustrate use of the flagpole).

FIG. 16 is a side view of another example of the flagpole shown with suction cups on the exterior of the window using a weakened area as the hinge on the foot, with a cross section of an automobile window and associated window frame (shown in dashed lines to illustrate use of the flagpole).

FIG. 17 is a side view of another example of the flagpole shown with suction cups on the exterior of the window using a flexible material, with a cross section of an automobile window and associated window frame (shown in dashed lines to illustrate use of the flagpole).

### DETAILED DESCRIPTION OF THE PREFERRED EMBODIMENTS

The descriptions and drawings discussed herein are merely to illustrate how to make and use this invention and are not to be interpreted as limiting in scope. Even though the devices and methods have been described with a degree of specificity, it is to be noted that many modifications may be made in the details of the construction and the arrangements of the components without departing from the spirit and scope contained herein. It is to be noted that the devices and methods are not limited to the embodiments set forth herein for purposes of exemplification.

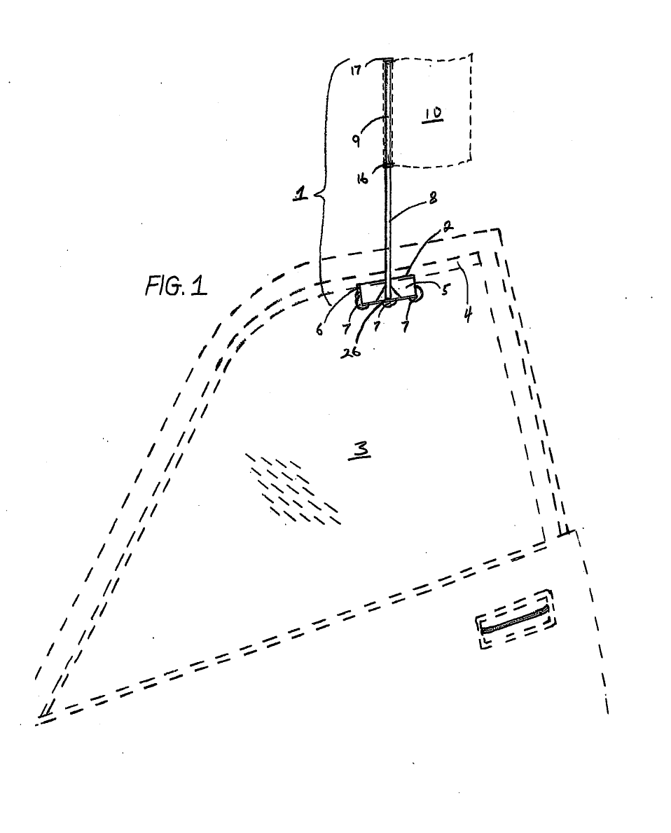

Referring now in detail to the drawings, wherein like numerals of reference designate like elements throughout the several different views, FIG. 1 shows an automobile flag. The flag pole 1 has a clip portion 2 that is shaped like a “U”, made up of an exterior portion 5 and interior portion 6 and fits over the top of the side window 3 of an automobile in which the flagpole 1 is held into place when the clip 2 is placed over the top of the lowered window 3 and either the window 3 is raised pinning the clip 2 in between the window 3 and the associated window frame 4 or when the suction cup(s) 7 on the interior section 6 of the clip 2 are pressed into place against the window 3, allowing the clip 2 to stay in place and the flagpole 1 to operate on a moving automobile with the window 3 ajar. The exterior portion 5 of the clip 2 is the attachment point for the lower portion 8 of the flagpole, at the base 26. A more slender upper portion 9 of the pole is affixed atop the lower section 8 in which the flag 10 is attached for display.

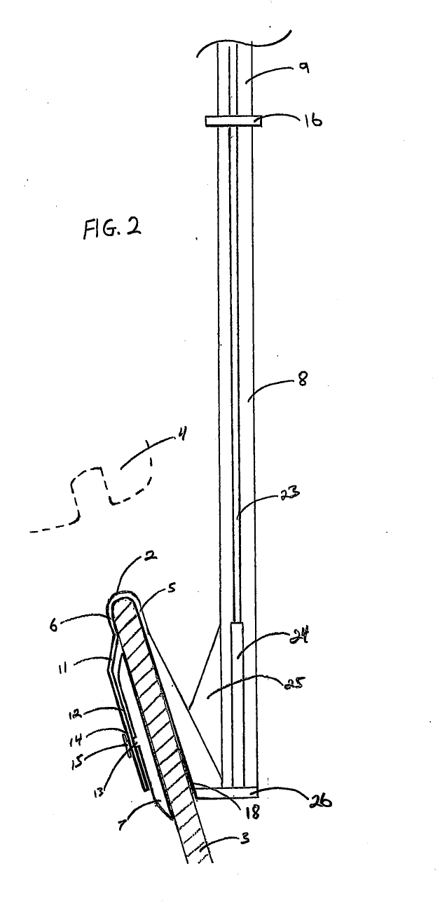

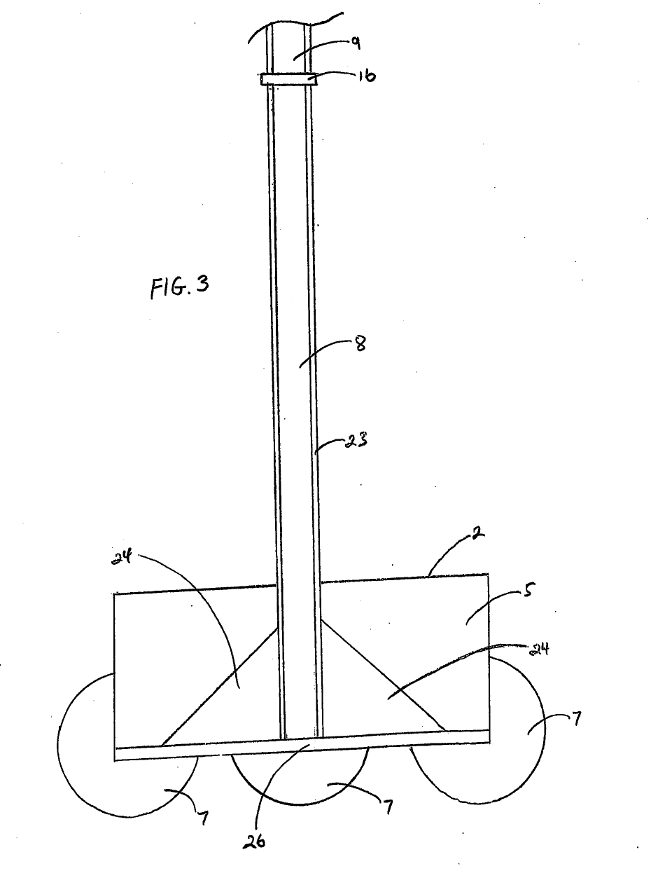

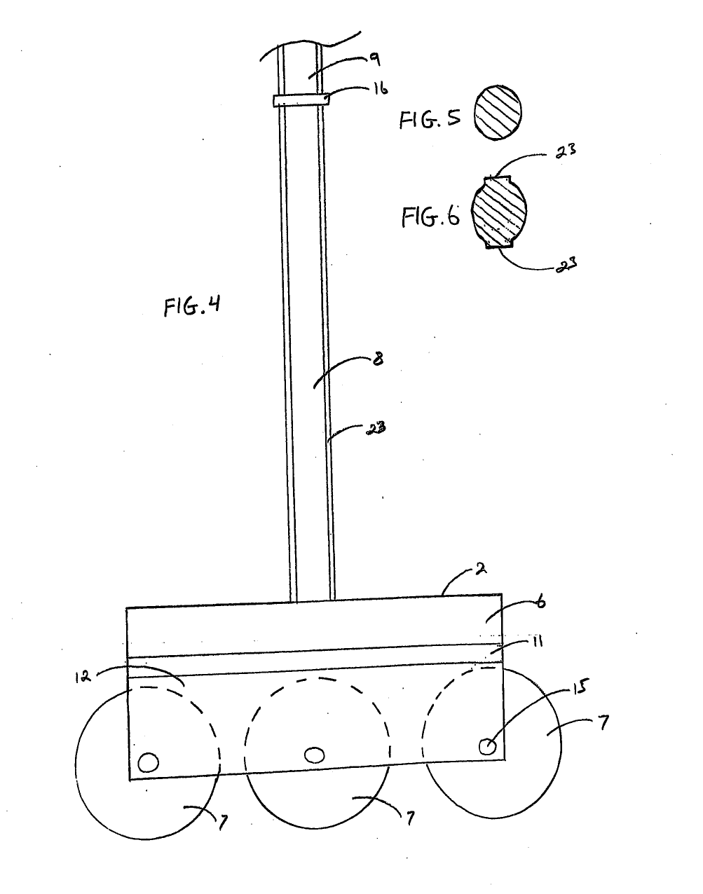

As seen in FIGS. 2, 3, 4, 5, and 6 the exterior portion 5 of the clip 2 provides for the attachment point of the lower straight portion 8 of the flagpole 1 at the base 26 while the interior portion 6 of the clip 2 extends downward just far enough to clear the window frame when the window 3 is completely rolled up, then juts out 11, to allow space for the suction cup(s) 7. The interior portion 6 and exterior portion 5 of the clip 2 are generally rectangular in order to provide the suction cups 7 adequate leverage to hold the flagpole 1 in place while the window 3 is open and the automobile is moving. The clip 2 has a “U” shaped profile in order to fit over the top of the automobile window 3 and is thin enough at the bend of the “U” to allow the window 3 to be rolled up or almost rolled up. A small piece of foam 18 may be attached to the inside area of the exterior portion 5 of the clip 2 to stop the exterior portion 5 of the clip 2 from rattling against the window. The interior portion 6 of the clip 2 follows the window 3 down just far enough to clear the window frame 4, then proceeds out and down 11 from the window 3 then the lower section 12 continues down in a manor parallel to the window 3. The lower portion 12 of the interior clip 6 has one or more attached suction cup(s) 7, attached generally in the corners if more than one suction cup 7 is used. The suction cup(s) 7 are attached on the interior portion 6 rather than the exterior portion 5 of the clip because they are generally protected from the heat, cold, wind and moisture, but primarily because the interior section 6 of the clip is the only portion of the flagpole that has minimal movement and is not directly in the path of the thrashings flagpole's 1 path of energy. Most of the energy is transferred down the flagpole 1, and into the exterior clip 5, stopping at the bend of the clip 2. The suction cup(s) 7 have a narrower portion 13 on the nipple with a slightly smaller diameter than the hole 14 removed in the lower portion 12 of the interior clip 6 in which the nipple 13 can be inserted through the hole 14 and the larger portion 15 on the tip of the nipple will secure the suction cup 7 to the lower portion 12 of the clip 6 or the suction cup(s) 7 can be attached by adhesive or other means. The straight portion 8,9 of the flagpole 1 may extend up far enough from the clip 2 for the flag 10 to clear the roof of the automobile; have a generally round cross section with raised edge on both sides 23 or other shaped cross-section, allowing for more ridged cross-section. The straight portion 8,9 may have a lip 16 located toward the middle of the pole 1 to keep the flag 10 from sliding down the pole 1 and a lip 17 at the top of the pole 1 to keep the flag 10 from blowing off of the pole 1. The upper portion 9 of the pole between the top lip 17 and middle lip 16 may be thinner than the section of the lower portion 8 of the pole 1 that attaches to the clip 2 and may also have a different cross section. The lower portion 8 of the pole may have braces 24 on either side extending down to the exterior portion 5 of the clip 2 and may also have an support at the attachment point. Many different types of suction cup(s) 7, other connection devices 7, or other technologies may be used to secure interior portion 6 of the clip 2 to the window 3.

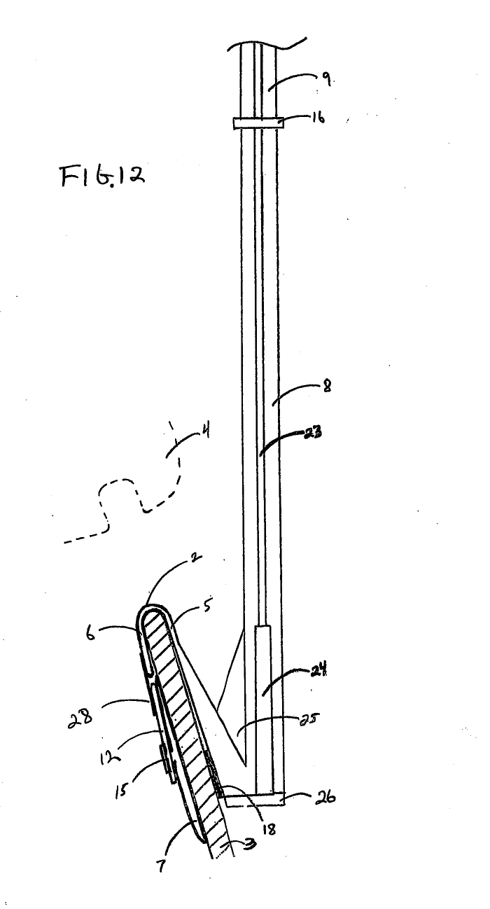

As, seen in FIG. 11, The above can be accomplished without the jutting out 11, of FIGS. 2 and 4, where the interior portion 6 of the clip 2 extends straight down from the window 3.

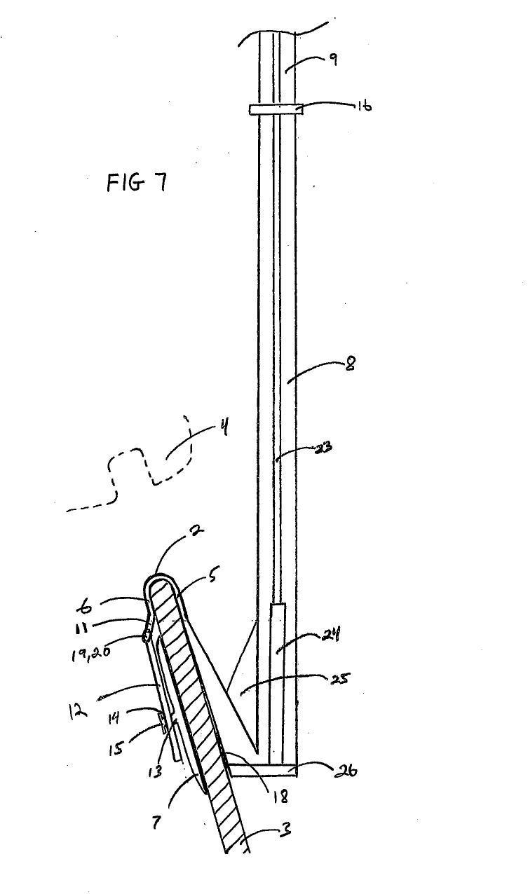

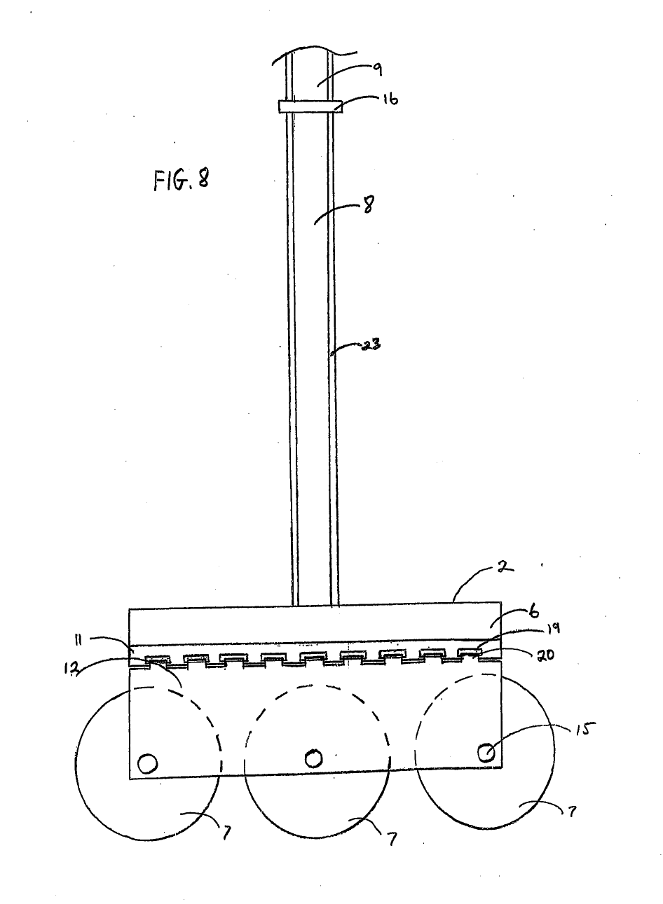

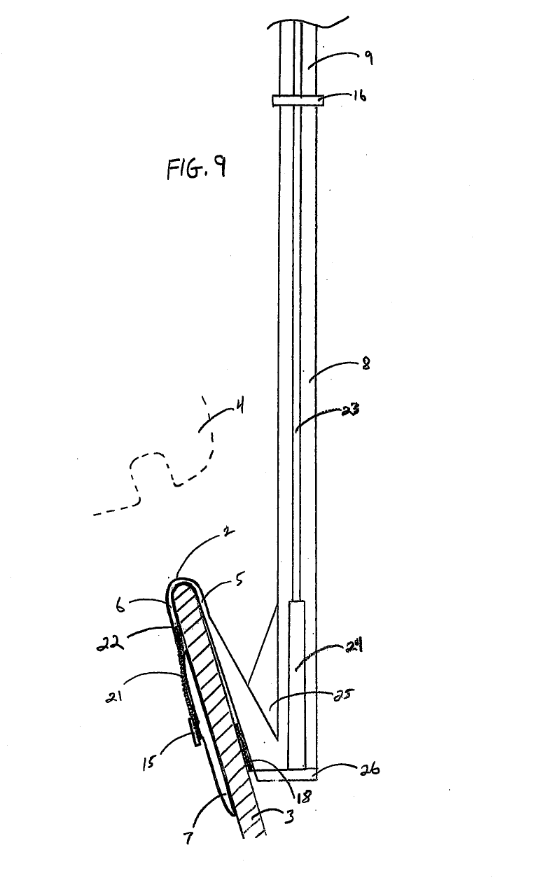

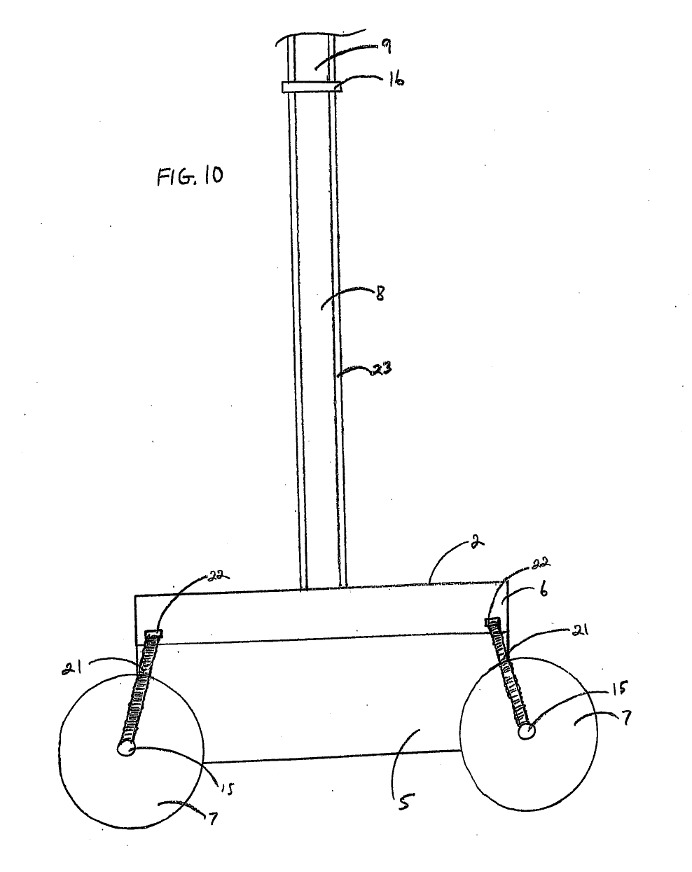

As seen in FIGS. 7 and 8 in an alternate embodiment, the interior portion 6 of the clip 2 comprises a hinge 19,20 located just low enough to clear the window frame 4, while the window 3 is in the rolled up position. The exterior portion 5 of the clip 2 and upper 9 and lower sections 8 of the straight section 8,9 are same as in the previous embodiment. The interior portion 6 of the clip 2 follows the window 3 down just far enough to clear the window frame 4, then proceeds out and down 11 from the window 3, then the lower section 12 is hinged onto the jutted out portion 11. The lower hinged portion proceeds to follow the plane of the glass, this jutting out 11 allows room for the suction cup(s) 7 between the lower portion 12 of the interior clip 6 and the glass 3. The lower portion 12 of the clip is hinged 19,20 onto the upper portion 6 allowing flexibility between the upper 6 and lower section 12, keeping the energy transfer between the thrashing flagpole 1 and the suction cup(s) 7 minimal and allowing the suction cup(s) 7 to remain fully seated. The hinge 19,20 may include several cut outs 19 in the upper section 6 with corresponding loops 20 in the lower section 12 that fit over the voids 19 in the upper sections 6, may include small rings that connect the two parts 6,12 and allows for flexibility. The lower section 12 and the upper section 6 may be modified to allow more space for the suction cup(s) 7 between the lower portion 12 and the window 3. Generally, the only force exerted on the suction cup(s) 7 is a vertical force allowing the suction cup(s) 7 to maximize their potential and eliminating all horizontal forces that may unseat the cup(s) 7. Many different types of suction cup(s) 7, connection devices 7, or similar technologies may be used to secure interior portion 6 of the clip 2 to the window 3.

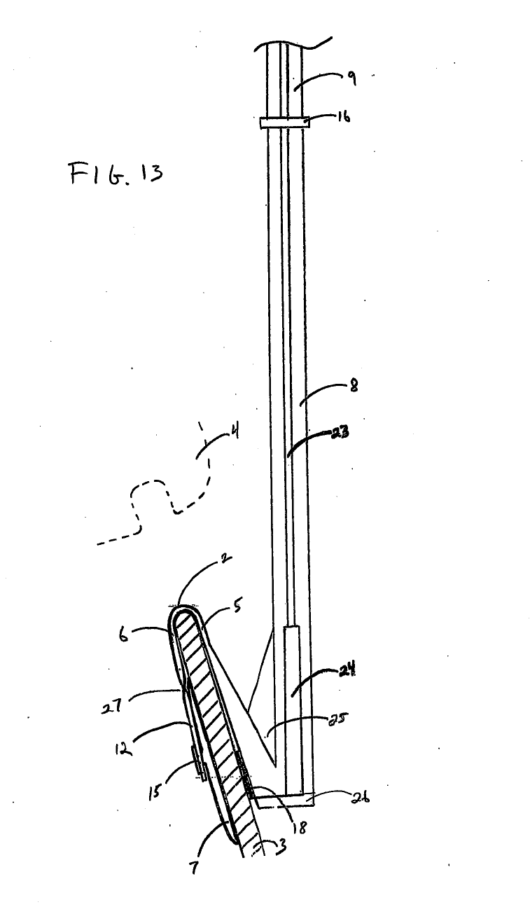

As seen in FIG. 12, the above hinged area can also be accomplished by using a flexible material 28 to connect the upper section 6 to the lower section 12.

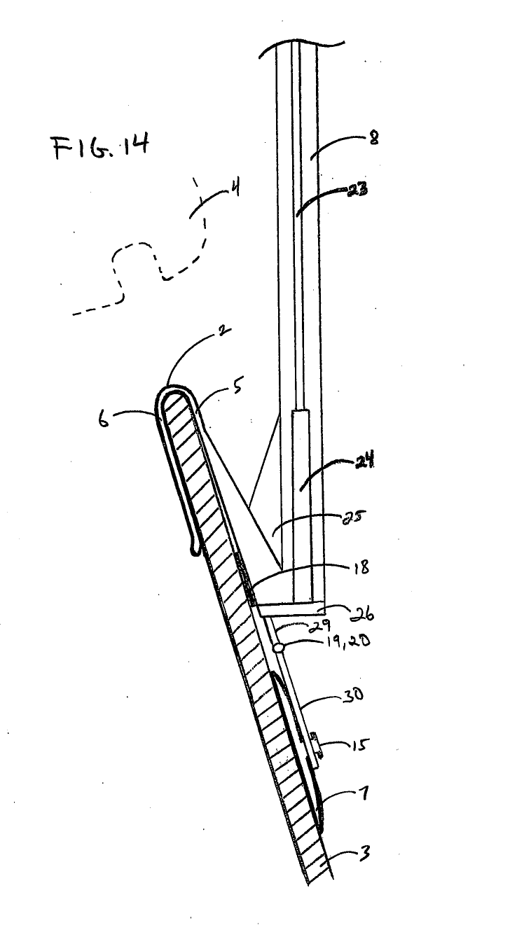

As seen in FIG. 13, the above hinged area can also be accomplished by removing sections of the plastic along the desired line 27, as to weaken the specific area of the plastic that needs to flex, thus connecting the upper section 6 to the lower section 12.

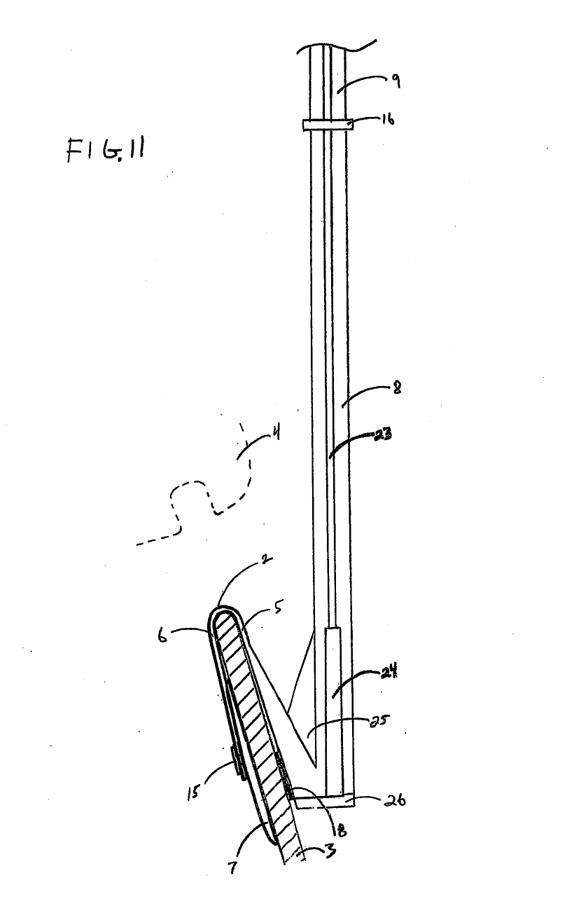

As seen in FIGS. 9 and 10 in an alternate embodiment to the above, the interior portion of the clip 6 comprises one or more suction cup(s) 7 that are attached to the interior portion 6 of the clip 2 by either a static or dynamic rope, spring(s) or other flexible material 21. The flexible material 21 is connected to the interior portion 6 of the clip 2 just low enough to clear the window frame 4 when the window 3 is in the raised position. The upper portion 6 of the interior portion of the clip is the same as in the embodiments above except that there are one or more attachment points 22 for the rope or other flexible material 21 to attach to. The suction cup(s) 7 are pulled down from the interior portion 6 of the clip 2 so the rope or other material 21 is taut; additionally, the rope or other material 21 can be pulled down and out to give the suction cup(s) 7 a greater point of leverage. Generally, the only force exerted on the suction cup(s) 7 in this embodiment is a vertical force and all horizontal forces are eliminated allowing the suction cup(s) 7 to stay seated. Additionally, the flexible and dynamic material 21 connecting the suction cup(s) 7 and the interior portion 6 of the clip 2 buffers the forces exerted on the suction cup (s) 7, allowing it 7 to stay seated. A static material may be used rather than a dynamic material 21, such as a metal or plastic clip. Many different types of suction cup(s) 7, connection devices 7 or other technologies may be used to secure interior portion 6 of the clip 2 to the window 3. This embodiment may be used as a retro fit on existing inventories of auto flag designs that have already been produced.

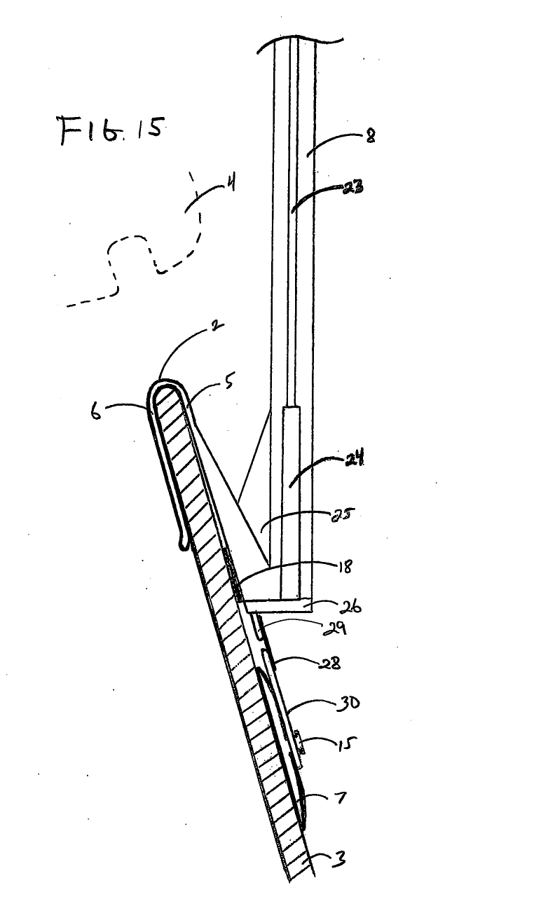

As seen in FIG. 14 in an embodiment very different from those above, a foot 29 on the exterior of the window 3, extends down from the base 26, and comprises a hinge 19, 20 that allows the lower section 30 with the attached suction cup(s) 7 to pivot separately from the rest of the flagpole 1.

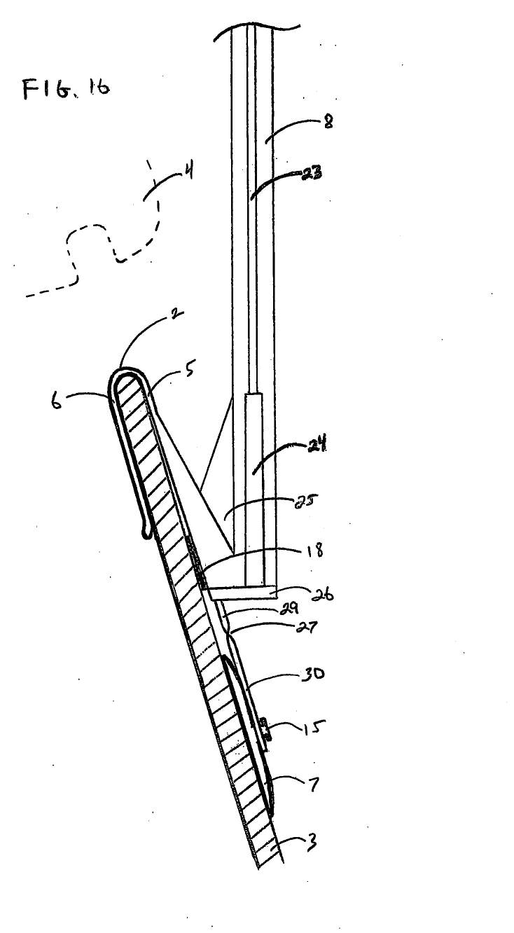

As seen in FIG. 15 in an embodiment similar to the one above, a foot 29 extends from the base 26 and comprises a flexible material 28 that connects the foot 29 to the lower section 30 with the attached suction cup(s) 7, which allows the lower section 30 to pivot separately from the rest of the flagpole 1.

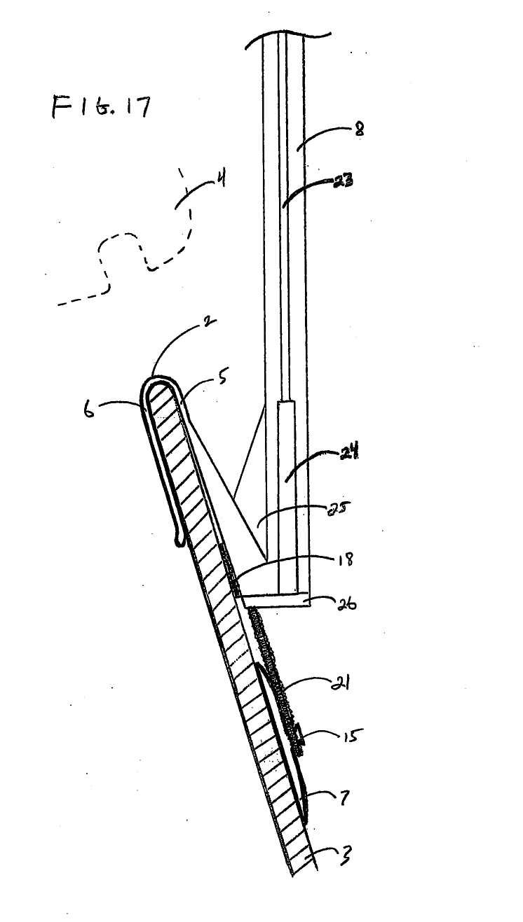

As seen in FIG. 16 in an embodiment similar to the two above, a foot 29 extends from the base 26 and comprises a hinge 27 that is a weakened area 27, that connects the foot 29 to the lower section 30 with the attached suction cup(s) 7, which allows the lower section 30 to pivot separately from the rest of the flagpole 1.

As seen in FIG. 17 in an embodiment similar to the three above, where the suction cup(s) 7 are attached by a flexible material 21, which allows give between the suction cup(s) 7 and the flagpole 1.

The flagpole 1 may be made of many different suitable materials, such as plastic and made in several different parts or as one part. If made of plastic, it could be made using plastic injection molding.

Whereas, the devices and methods have been described in relation to the drawings, it should be understood that other and further modification, apart from those shown or suggested herein, may be made within the spirit and scope of this invention.

What is claimed is:

1. A flagpole comprising:
a base;
at least one clip portion attached to the base, allowing the base to be clipped onto a window;
at least one elongated portion extends from the base;
an interior section of the clip extends from the edge of the window; and
at least one connection device secures the interior section of the clip to the window.

2. The flagpole of claim 1 where at least one item of display is attached to the elongated portion.

3. The flagpole of claim 1 where the interior of the clip extends down from the edge of the window, runs parallel to the window and at least one suction cup is attached to the interior of the clip.

4. The flagpole of claim 1 where the interior of the clip extends down and at least one suction cup is attached by a flexible material to the interior of the clip.

5. The flagpole of claim 1 where the interior of the clip extends down just enough to clear the door frame, then juts out and down, to allow room for a suction cup in between the interior clip and the window.

6. The flagpole of claim 5 where the interior portion of the clip comprises a pivotal joint, located below the jut out, which allows at least one suction cup to pivot from the rest of the flagpole.

7. The flagpole of claim 6 where the pivotal joint comprises a weakened area of the interior of the clip that allows at least one suction cup to pivot from the rest of the flagpole.

8. The flagpole of claim 6 where the pivotal joint comprises a flexible material that allows at least one suction cup to pivot from the rest of the flagpole.

9. The flagpole of claim 6 where the pivotal joint comprises hinge that allows at least one suction cup to pivot from the rest of the flagpole.

10. A flagpole comprising:
a base;
at least one clip portion is attached to the base, allowing the base to be clipped onto a window;
at least one elongated portion extends from the base;
at least one pivotal foot extends from the exterior portion of the flagpole, and
at least at least one connection device secures the foot to the window.

11. The flagpole of claim 10 where at least one item for display is attached to the elongated portion.

12. The flagpole of claim 10 where the foot is comprised of flexible material and at least one suction cup is attached to the foot.

13. The flagpole of claim 10 where the foot comprises a joint.

14. The flagpole of claim 13 where the joint comprises a weakened area in the foot, allowing at least one suction cup to pivot separately from the base.

15. The flagpole of claim 13 where the joint comprises a hinge, allowing at least one suction cup to pivot separately from the base.

16. The flagpole of claim 13 where the joint comprises a flexible material, allowing at least one suction cup to pivot separately from the base.
